(19) United States
(12) Patent Application Publication
(10) Pub. No.: US 2025/0256305 A1
(43) Pub. Date: Aug. 14, 2025

(54) CLEANING DEVICE

(71) Applicants: Hefei BOE Vision-Electronic Technology Co., Ltd., Hefei, Anhui (CN); BOE Technology Group Co., Ltd., Beijing (CN)

(72) Inventors: Meng Wang, Beijing (CN); Qiu Zhou, Beijing (CN); Yaguang Ma, Beijing (CN); Zhencheng Fu, Beijing (CN); Jiaqi Qian, Beijing (CN); Mingsheng Xu, Beijing (CN)

(73) Assignees: Hefei BOE Vision-Electronic Technology Co., Ltd., Hefei, Anhui (CN); BOE Technology Group Co., Ltd., Beijing (CN)

(21) Appl. No.: 18/702,408

(22) PCT Filed: Apr. 28, 2023
(86) PCT No.: PCT/CN2023/091706

§ 371 Date: Apr. 18, 2024

(30) Foreign Application Priority Data
May 27, 2022 (CN) 202210603792.6

(51) Int. Cl. B08B 1/32; B08B 1/12; B08B 5/04; B08B 13/00

(52) U.S. Cl. CPC B08B 1/32; B08B 1/12; B08B 5/04; B08B 13/00

(57) ABSTRACT

A cleaning device is provided. The cleaning device includes a cleaning assembly, a driving controlling assembly, a bottom plate and a diagnosis feeding-back assembly; both of the cleaning assembly and the driving controlling assembly are fixed on the bottom plate, and the driving controlling assembly and the cleaning assembly are connected; the bottom plate is provided with a cleaning through slot, the diagnosis feeding-back assembly is connected to the bottom plate, and the diagnosis feeding-back assembly is configured to detect a relative position between the current-collection box and the bottom plate, and configured to detect a power-on state of the current-collection box; and when it is detected by the diagnosis feeding-back assembly that the current-collection box is located at a bottom of the bottom plate, the driving controlling assembly drives the cleaning assembly to, by using the cleaning through slot, remove a foreign matter on the current-collection box.

### CROSS REFERENCE TO RELEVANT APPLICATIONS

The present application claims the priority of the Chinese patent application filed on May 27, 2022 before the Chinese Patent Office with the application number of 202210603792.6 and the title of “CLEANING DEVICE”, which is incorporated herein in its entirety by reference.

### TECHNICAL FIELD

The present disclosure relates to the technical field of automated equipment and, more particularly, to a cleaning device.

### BACKGROUND

A current-collection box is an integrated component used to supply power for the tooling plate on an assembly line, and its power-on state directly decides whether the tooling plate on the assembly line is powered, which influences whether the tooling plate can supply the electric power on the assembly line for the display screen.

In the long-term usage of the current-collection box, the problems of smudge, grease and line damage easily emerge, therefore the current-collection box requires maintenance and periodical cleaning and diagnosis.

Currently, the cleaning and diagnosis of the current-collection boxes are usually done artificially. For the assembly lines using a large quantity of current-collection boxes, the artificial mode is time-consuming and labor-consuming, and has a low efficiency, thus the cleaning and diagnosis cannot be realized in a short time, and the current-collection box in an abnormal state cannot be detected artificially and quickly, which causes great difficulties for the subsequent operator to maintain and replace the current-collection box.

### SUMMARY

A cleaning device is provided by the embodiments of the present disclosure to solve the problem in the related art that the cleaning and the diagnosis of current-collection boxes is time-consuming and labor-consuming.

In order to solve the technical problem stated above, the present disclosure is realized as follows:

A cleaning device is provided by the embodiments of the present disclosure, configured for cleaning a current-collection box, wherein the cleaning device includes a cleaning assembly, a driving controlling assembly, a bottom plate and a diagnosis feeding-back assembly;
both of the cleaning assembly and the driving controlling assembly are fixed on the bottom plate, and the driving controlling assembly and the cleaning assembly are connected;
the bottom plate is provided with a cleaning through slot, the diagnosis feeding-back assembly is connected to the bottom plate, and the diagnosis feeding-back assembly is configured to detect a relative position between the current-collection box and the bottom plate, and configured to detect a power-on state of the current-collection box; and
when it is detected by the diagnosis feeding-back assembly that the current-collection box is located at a bottom of the bottom plate, the driving controlling assembly drives the cleaning assembly to, by using the cleaning through slot, remove a foreign matter on the current-collection box.

Optionally, the cleaning assembly includes a cleaning chain, a cleaning roller and a cleaning chain wheel, and the driving controlling assembly includes a driving chain wheel, a driving motor and a controller;
the controller and the driving motor are connected, and the controller controls the driving motor to rotate; and
a cleaning brush is fixed on a surface of the cleaning roller, the driving chain wheel is connected to an end of an output shaft of the driving motor, the cleaning chain is connected to the driving chain wheel and the cleaning chain wheel, and the cleaning chain wheel is fixed at an input end of the cleaning roller.

Optionally, the cleaning assembly further includes a cleaning hood body; and
the cleaning hood body is covered on the cleaning roller.

Optionally, the cleaning device further includes a cleaning fixing seat and a cleaning supporting seat; and
the cleaning roller is fixed on the cleaning fixing seat, and the cleaning fixing seat is fixed on the bottom plate via the cleaning supporting seat.

Optionally, the cleaning device further includes a cleaning vacuum cleaner; and
the cleaning vacuum cleaner is in communication with the cleaning hood body, the cleaning vacuum cleaner is electrically connected to the controller, and the controller controls the cleaning vacuum cleaner to suck a foreign matter in the cleaning hood body.

Optionally, the cleaning assembly further includes a polishing chain, a polishing chain wheel and a polishing roller, and the driving chain wheel is a duplex chain wheel;
the polishing roller and the cleaning roller are located at two sides of the driving motor; and
a polishing brush is fixed on the cleaning roller, the polishing chain wheel is fixed at an input end of the polishing roller, the polishing chain is connected to the polishing chain wheel and the driving chain wheel, and the driving chain wheel is fixed at an end of the polishing roller.

Optionally, the cleaning assembly further includes a polishing hood body; and
the polishing hood body is covered on the polishing roller.

Optionally, the cleaning device further includes a polishing fixing seat and a polishing supporting seat; and
the polishing roller is fixed on the polishing fixing seat, and the polishing fixing seat is fixed on the polishing supporting seat.

Optionally, the cleaning device further includes a polishing vacuum cleaner, the polishing vacuum cleaner is in communication with the polishing hood body, the polishing vacuum cleaner is electrically connected to the controller, and the controller controls the polishing vacuum cleaner to suck a foreign matter inside the polishing hood body.

Optionally, the cleaning device further includes a diagnosis feeding-back assembly;
the diagnosis feeding-back assembly includes an in-position travel switch and an off-position travel switch, the in-position travel switch and the off-position travel switch are fixed on the bottom plate, and the in-position travel switch and the off-position travel switch are electrically connected to the controller; and
the in-position travel switch is configured to detect that the current-collection box is located at a first position of the bottom plate, and the off-position travel switch is configured to detect that the current-collection box is located at a second position of the bottom plate;
wherein the first position refers to a position where the current-collection box and the bottom plate coincide in a first direction, and the second position refers to a position where the bottom plate is in stagger in the first direction, wherein the first direction refers to a direction perpendicular to the bottom plate.

Optionally, the diagnosis feeding-back assembly further includes a contactor, the bottom plate is provided with a cable, and the contactor is electrically connected to the cable; and
the contactor is configured to detect the power-on state of the current-collection box.

Optionally, the diagnosis feeding-back assembly further includes a position marking component, and the position marking component is configured to mark a first target current-collection box, wherein the first target current-collection box refers to a current-collection box in a powering-off state.

Optionally, the diagnosis feeding-back assembly further includes an indicator lamp, the indicator lamp is electrically connected to the controller, and when it is detected by the contactor that the current-collection box is in a powering-off state, the indicator lamp is in a lightening state.

Optionally, the position marking component includes a straight-line driver and a marking pen; and
the marking pen is fixed on the straight-line driver, and when it is detected by the contactor that the current-collection box is in the powering-off state, the straight-line driver drives the marking pen to make a mark on the current-collection box.

Optionally, the position marking component further includes a display panel; and
the display panel is electrically connected to the current-collection box, and when the current-collection box is marked by the marking pen, the display panel displays a position of the current-collection box.

Optionally, the cleaning device further includes a protecting hood body; and
the protecting hood body is covered on the diagnosis feeding-back assembly and the driving controlling assembly.

In the embodiments of the present disclosure, because both of the cleaning assembly and the driving controlling assembly are fixed on the bottom plate, in the washing of the current-collection box, the bottom plate can be moved to the top of the current-collection box, so that the cleaning assembly and the driving controlling assembly are located at the top of the current-collection box. Further, because the driving controlling assembly and the cleaning assembly are connected, and the bottom plate is provided with a cleaning through slot, when it is detected by the diagnosis feeding-back assembly that the current-collection box is located at the bottom of the bottom plate, the driving controlling assembly can drive the cleaning assembly to, by using the cleaning through slot, remove a foreign matter on the current-collection box, thereby the automated washing of the current-collection box is realized. In this way, in an aspect, by using the cleaning assembly and the driving controlling assembly, the process of washing the current-collection box can be time-saving and labor-saving, and the washing of the current-collection box can be completed within a short time, which facilitates to increase the efficiency of the washing of the current-collection box. In another aspect, the relative position between the cleaning device and the current-collection box can be determined accurately by using the diagnosis feeding-back assembly, so that the process of washing the current-collection box is more accurate and controllable, and the current-collection box in an abnormal state can be diagnosed quickly by using the diagnosis feeding-back assembly, thereby the current-collection box in an abnormal state is facilitated to be subsequently maintained and replaced.

### BRIEF DESCRIPTION OF THE DRAWINGS

In order to more clearly illustrate the technical solutions of the embodiments of the present disclosure or the prior art, the figures that are required to be used to describe the embodiments or the prior art will be briefly introduced below. Apparently, the figures that are described below are some embodiments of the present disclosure, and a person skilled in the art can obtain other figures according to these figures without paying creative work.

FIG. 1 shows a schematic diagram of an exterior structure of a cleaning device according to an embodiment of the present disclosure;

FIG. 2 shows a schematic diagram of an interior structure of a cleaning device according to an embodiment of the present disclosure; and

FIG. 3 shows a schematic diagram of a bottom structure of a cleaning device according to an embodiment of the present disclosure.

### REFERENCE NUMBERS

1: cleaning assembly; 2: driving controlling assembly; 3: bottom plate; 4: diagnosis feeding-back assembly; 5: protecting hood body; 11: cleaning chain; 12: cleaning roller; 13: cleaning chain wheel; 14: cleaning brush; 15: cleaning hood body; 16: cleaning fixing seat; 17; cleaning supporting seat; 18: cleaning vacuum cleaner; 19: collecting box; 21: driving chain wheel; 22: driving motor; 23: controller; 31: cleaning through slot; 41: in-position travel switch; 42: off-position travel switch; 43: contactor; 44: position marking component; 45: indicator lamp; 101: polishing chain; 102: polishing chain wheel; 103: polishing roller; 104: polishing brush; 105: polishing hood body; 106; polishing fixing seat; 107: polishing supporting seat; 108: polishing vacuum cleaner; 441: straight-line driver; 442: marking pen; and 443: display panel.

### DETAILED DESCRIPTION

The technical solutions according to the embodiments of the present disclosure will be clearly and completely described below with reference to the drawings according to the embodiments of the present disclosure. Apparently, the described embodiments are merely a certain embodiments of the present disclosure, rather than all of the embodiments. All of the other embodiments that a person skilled in the art obtains on the basis of the embodiments of the present disclosure without paying creative work fall within the protection scope of the present disclosure.

It should be understood that the “one embodiment” or “an embodiment” as used throughout the description means that particular features, structures or characteristics with respect to the embodiments are included in at least one embodiment of the present disclosure. Therefore, the “in one embodiment” or “in an embodiment” as used throughout the description does not necessarily refer to the same embodiment. Furthermore, those particular features, structures or characteristics may be combined in one or more embodiments in any suitable form.

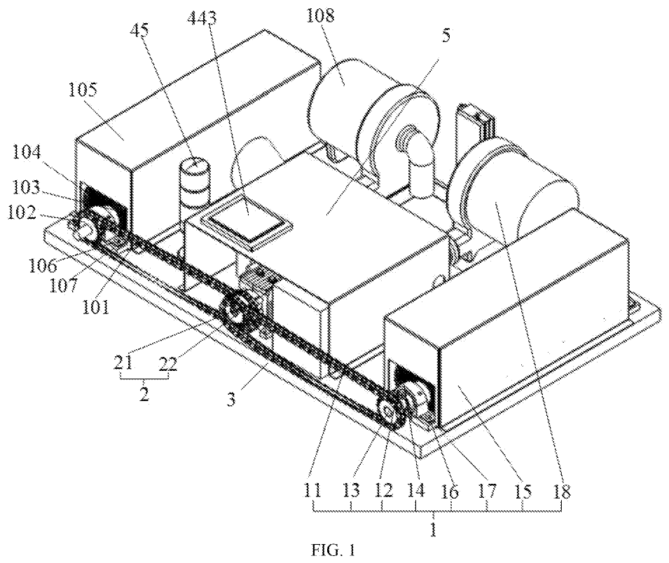

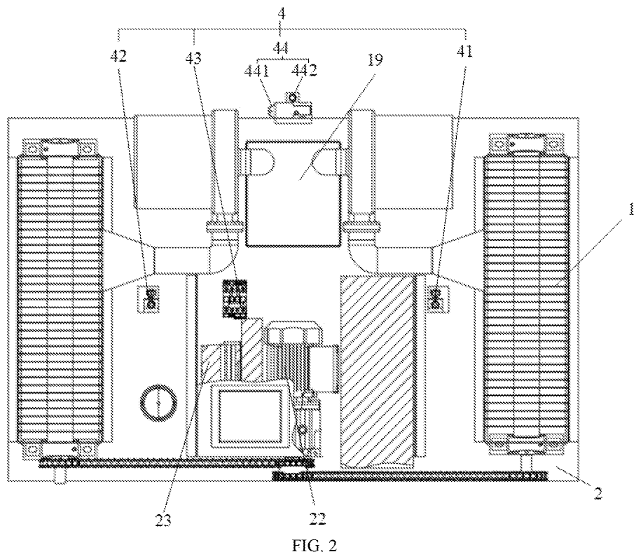

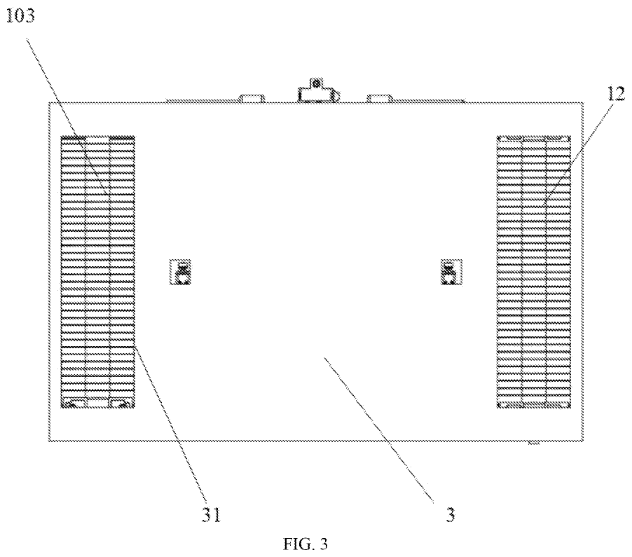

A cleaning device is provided by the embodiments of the present disclosure. FIG. 1 shows a schematic diagram of an exterior structure of a cleaning device according to an embodiment of the present disclosure. FIG. 2 shows a schematic diagram of an interior structure of a cleaning device according to an embodiment of the present disclosure. FIG. 3 shows a schematic diagram of a bottom structure of a cleaning device according to an embodiment of the present disclosure. As shown in FIGS. 1, 2 and 3, the cleaning device is configured for cleaning a current-collection box, and includes a cleaning assembly 1, a driving controlling assembly 2, a bottom plate 3 and a diagnosis feeding-back assembly 4. Both of the cleaning assembly 1 and the driving controlling assembly 2 are fixed on the bottom plate 3, and the driving controlling assembly 2 and the cleaning assembly 1 are connected. The bottom plate 3 is provided with a cleaning through slot 31, the diagnosis feeding-back assembly 4 is connected to the bottom plate 3, and the diagnosis feeding-back assembly 4 is configured to detect the relative position between the current-collection box and the bottom plate 3, and configured to detect a power-on state of the current-collection box. When it is detected by the diagnosis feeding-back assembly that the current-collection box is located at the bottom of the bottom plate, the driving controlling assembly 2 drives the cleaning assembly 1 to, by using the cleaning through slot 31, remove a foreign matter on the current-collection box.

The bottom plate 3 is the supporting member for fixing the cleaning assembly 1 and the driving controlling assembly 2. Various connectors and sockets may be disposed on the bottom plate 3. In usage, the bottom plate 3 is moved along a predetermined trajectory, and accordingly moved to the top of the to-be-cleaned current-collection box, thereby the current-collection box is cleaned or detected. In addition, the bottom plate 3 may be manufactured directly by using the tooling plate in an assembly line, which facilitates to save the manufacturing cost, and facilitates the maintenance in the later stage.

The cleaning assembly 1 disposed on the bottom plate 3 may include one set of cleaning member, for example, an automatic cleaning brush 14, may also include a plurality of sets of cleaning members, for example, a cleaning roller 12 and a polishing roller 103 that are used together, or may include other device configured for cleaning the current-collection box, which is not limited in the embodiments of the present disclosure. The driving controlling assembly 2 is a device configured for driving and controlling the cleaning assembly 1 to perform the foreign-matter removal to the cleaning assembly 1, and may include a driving element and a controlling element. The cleaning through slot 31 disposed in the bottom plate 3 should be corresponded to the position of the cleaning assembly 1 that is configured for removing the foreign matter, so that the position of the cleaning assembly 1 that is configured for removing the foreign matter can contact the current-collection box via the cleaning through slot 31, thus, when the driving controlling assembly 2 drives the cleaning assembly 1 to move, the foreign matter on the current-collection box can be removed.

Additionally, in the embodiments of the present disclosure, the diagnosis feeding-back assembly 4 may be used to determine the relative position between the cleaning device and the current-collection box and detect whether the current-collection box is in an abnormal state. When it is detected by the diagnosis feeding-back assembly that the current-collection box is located at the bottom of the bottom plate, the driving controlling assembly 2 drives the cleaning assembly 1 to, by using the cleaning through slot 31, remove the foreign matter on the current-collection box. In this way, the relative position between the cleaning device and the current-collection box can be determined accurately by using the diagnosis feeding-back assembly 4, so that the process of washing the current-collection box is more accurate and controllable, and the power-on state of the current-collection box in an abnormal state can be diagnosed quickly by using the diagnosis feeding-back assembly 4, thereby the function of detecting the state of the current-collection box is realized.

It can be seen from the above embodiments that, in the embodiments of the present disclosure, because both of the cleaning assembly 1 and the driving controlling assembly 2 are fixed on the bottom plate 3, in the washing of the current-collection box, the bottom plate 3 can be moved to the top of the current-collection box, so that the cleaning assembly 1 and the driving controlling assembly 3 are located at the top of the current-collection box. Further, because the driving controlling assembly 2 and the cleaning assembly 1 are connected, and the bottom plate 3 is provided with a cleaning through slot 31, when it is detected by the diagnosis feeding-back assembly 4 that the current-collection box is located at the bottom of the bottom plate 3, the driving controlling assembly 2 can drive the cleaning assembly 1 to, by using the cleaning through slot 31, remove a foreign matter on the current-collection box, thus the automated washing of the current-collection box is realized. Accordingly, in an aspect, by using the cleaning assembly 1 and the driving controlling assembly 3, the process of washing the current-collection box can be time-saving and labor-saving, and the washing of the current-collection box can be completed within a short time, the efficiency of the washing of the current-collection box is facilitated to be increased. In another aspect, the relative position between the cleaning device and the current-collection box can be determined accurately by using the diagnosis feeding-back assembly 4, so that the process of washing the current-collection box is more accurate and controllable, and the current-collection box in an abnormal state can be diagnosed quickly by using the diagnosis feeding-back assembly 4, thereby the current-collection box in an abnormal state is facilitated to be subsequently maintained and replaced.

The specific structures of the cleaning assembly 1 and the driving controlling assembly 2 will be explained specifically below:

In some embodiments, the cleaning assembly 1 may include a cleaning chain 11, a cleaning roller 12 and a cleaning chain wheel 13, and the driving controlling assembly 2 includes a driving chain wheel 21, a driving motor 22 and a controller 23. The controller 23 and the driving motor 22 are connected, and the controller 23 controls the driving motor 22 to rotate. The driving chain wheel 21 is connected to an end of the output shaft of the driving motor 22, the cleaning chain 11 is connected to the driving chain wheel 21 and the cleaning chain wheel 13, and the cleaning chain wheel 13 is fixed at the input end of the cleaning roller 12.

It should be noted that the cleaning chain 11 is a metal chain of a chain link or a ring. In the assembling, the cleaning chain 11 is connected to the driving chain wheel 21 and the cleaning chain wheel 13. Because the driving chain wheel 21 is connected to an end of the output shaft of the driving motor 22, and the cleaning chain wheel 13 is fixed at the input end of the cleaning roller 12, when the controller 23 controls the driving motor 22 to rotate, the output shaft of the driving motor 22 also rotates, and in turn drives the driving chain wheel 21 disposed at the end of the output shaft of the driving motor 22 to rotate. When the driving chain wheel 21 rotates, the cleaning chain 11 mounted to the driving chain wheel 21 can be rotated, so that the power transmitted by the cleaning chain 11 reaches the cleaning chain wheel 13, thus the cleaning chain wheel 13 rotates. While the cleaning chain wheel 13 rotates, it drives the cleaning roller 12 to rotate, and accordingly the function of removing the foreign matter of the current-collection box is reached by the rotation of the cleaning roller 12.

It should also be noted that both of the cleaning chain wheel 13 and the driving chain wheel 21 are of a disk-like structure of which the end face is a sprocket, which, in the assembling, can be engaged with the cleaning chain 11, thereby the synchronous rotation of the cleaning chain wheel 13 and the driving chain wheel 21 is realized. In the embodiments of the present disclosure, the diameter of the cleaning chain wheel 13 and the diameter of the driving chain wheel 21 may be equal, and may also be unequal, and the particular diameters are decided according to the transmission ratio between the driving motor 22 and the cleaning roller 12, and are not limited in the embodiments of the present disclosure. In addition, the driving motor 22 may be a gear motor, a servomotor or other motors, which is also not limited in the embodiments of the present disclosure.

Additionally, the cleaning assembly 1 further includes a cleaning brush 14, and the cleaning brush 14 is fixed on the surface of the cleaning roller 12. It should be noted that the cleaning brush 14 may be of a rectangular sheet-like structure, and, in the assembling, may be wrapped on the surface of the cleaning roller 12, so that the cleaning face of the cleaning brush 14 faces the cleaning through slot 31. Accordingly, while the cleaning roller 12 rotates, it can drive the cleaning face of the cleaning brush 14 to contact the current-collection box, thereby the foreign matter on the current-collection box is wiped.

Furthermore, the cleaning assembly 1 further includes a cleaning hood body 15. The cleaning hood body 15 is covered on the cleaning roller 12.

It should be noted that the cleaning hood body 15 may be a square housing, and may also be a cylindrical housing. The bottom face of the cleaning hood body 15 and the cleaning through slot 31 may be communicated by means of disposing a through slot at the bottom of the cleaning hood body 15 or configuring the bottom face of the cleaning hood body 15 to have an opening, and so on. When the cleaning hood body 15 is covered on the cleaning roller 12, in an aspect the cleaning roller 12 can be protected, and in another aspect, the foreign matter of the current-collection box removed by the cleaning roller 12 can be collected into the inner cavity of the cleaning hood body 15, which, while facilitating the collection and the treatment of the foreign matter, can prevent splashing of the foreign matter from affecting the working environment.

Optionally, the cleaning device further includes a cleaning fixing seat 16 and a cleaning supporting seat 17. The cleaning roller 12 is fixed on the cleaning fixing seat 16, and the cleaning fixing seat 16 is fixed on the bottom plate 3 via the cleaning supporting seat 17.

It should be noted that the cleaning fixing seat 16 may be a support having a connecting component. As an example, the cleaning fixing seat 16 may include two lugs having a bolt hole, and by using the two lugs, the cleaning roller 12 is enabled to be fixed between the two lugs, so that the cleaning fixing seat 16 can enable the cleaning roller 12 to maintain the position stability. The cleaning fixing seat 16 is fixed on the bottom plate 3 via the cleaning supporting seat 17. In this way, the cleaning supporting seat 17 can support the cleaning roller 12 to a certain extent, to prevent the cleaning roller 12 from being directly fixed on the bottom plate 3, and a sufficient room for the rotation of the cleaning roller 12 can be left by using the cleaning supporting seat 17, thus the entire structure is more compact.

Furthermore, the cleaning device further includes a cleaning vacuum cleaner 18. The cleaning vacuum cleaner 18 is in communication with the cleaning hood body 15, the cleaning vacuum cleaner 18 is electrically connected to the controller 23, and the controller 23 controls the cleaning vacuum cleaner 18 to suck a foreign matter in the cleaning hood body 15.

It should be noted that the cleaning vacuum cleaner 18 may be communicated with the cleaning hood body 15 by using a pipeline. Accordingly, when the foreign matter stored in the cleaning hood body 15 reaches a certain quantity, the foreign matter can be sucked into the cleaning vacuum cleaner 18, thereby a long-term and effective operation of the cleaning device is realized, and the normal movement of the cleaning roller 12 is prevented being affected by accumulation of the foreign matter.

In addition, in order to further enhance the effect of the foreign-matter removal by the cleaning assembly 1, and in order to further increase the degree of the cleanliness of the current-collection box, in another alternative implementation, the cleaning assembly 1 further includes a polishing chain 101, a polishing chain wheel 102 and a polishing roller 103, and the driving chain wheel 21 is a duplex chain wheel.

The polishing roller 103 and the cleaning roller 12 are located at the two sides of the driving motor 22, the polishing chain wheel 102 is fixed at the input end of the polishing roller 103, the polishing chain 101 is connected to the polishing chain wheel 102 and the driving chain wheel 21, and the driving chain wheel 21 is fixed at an end of the polishing roller 103.

It should be noted that the polishing chain 101 is a metal chain of a chain link or a ring, and the polishing chain wheel 102 is of a disk-like structure of which the end face is a sprocket. In the assembling, the polishing chain 101 is engaged with the driving chain wheel 21 and the polishing chain wheel 102. Because the polishing chain 101 is connected to the polishing chain wheel 102 and the driving chain wheel 21, and the driving chain wheel 21 is fixed at an end of the polishing roller 103. When the controller 23 controls the driving motor 22 to rotate, the output shaft of the driving motor 22 also rotates, and in turn drives the driving chain wheel 21 disposed at the end of the output shaft of the driving motor 22 to rotate. When the driving chain wheel 21 rotates, the polishing chain 101 mounted to the driving chain wheel 21 can be rotated, so that the power transmitted by the polishing chain 101 reaches the polishing chain wheel 102, so that the polishing chain wheel 102 rotates. While the polishing chain wheel 102 rotates, it drives the polishing roller 103 to rotate, and accordingly the function of further removing the foreign matter of the current-collection box is reached by the rotation of the polishing roller 103.

It should also be noted that, because the polishing roller 103 and the cleaning roller 12 are located at the two sides of the driving motor 22, in the removal of the foreign matter of the current-collection box, a primary removal may be performed by using the cleaning roller 12, and subsequently a secondary removal may be performed by using the polishing roller 103, so that the effect of the foreign-matter removal of the current-collection box is further improved. In addition, in order to enable the same driving motor 22 to simultaneously drive the polishing roller 103 and the cleaning roller 12 to rotate, in the embodiments of the present disclosure, the driving chain wheel 21 is a duplex chain wheel; in other words, the driving chain wheel 21 is simultaneously engaged with the polishing chain and the cleaning chain 11, which, while simplifying the transmission path, reduces the volume of the cleaning device, and can serve to save electricity. When the above issues are not taken into consideration, in the embodiments of the present disclosure, two driving motors 22 may also be disposed, and the two driving motors 22 may be separately used to drive the polishing roller 103 and the cleaning roller 12 to rotate, which can also serve to further remove the foreign matter of the current-collection box.

Additionally, the cleaning assembly 1 further includes a polishing brush 104. The polishing brush 104 is fixed on the polishing roller 103. It should be noted that the polishing brush 104 may be of a rectangular sheet-like structure, and, in the assembling, may be wrapped on the surface of the polishing roller 103, so that the cleaning face of the polishing brush 104 faces the cleaning through slot 31. Accordingly, while the polishing roller 103 rotates, it can drive the cleaning face of the polishing brush 104 to contact the current-collection box, thereby the secondary removal is performed to the foreign matter on the current-collection box.

It should also be noted that, in order to enable the cleaning through slot 31 to be suitable for the operations of the cleaning brush 14 and the polishing brush 104 simultaneously, in the embodiments of the present disclosure, the area of the opening of the cleaning through slot 31 may be increased, so that the cleaning through slot 31 faces the cleaning brush 14 and the polishing brush 104 simultaneously. One cleaning through slot 31 may also be disposed at the position facing the cleaning brush 14, and one cleaning through slot 31 may be provided at the position facing the polishing brush 104, which is not limited in the embodiments of the present disclosure.

Furthermore, the cleaning assembly 1 further includes a polishing hood body 105. The polishing hood body 105 is covered on the polishing roller 103.

It should be noted that the polishing hood body 105 may be a square housing, and may also be a cylindrical housing. The bottom face of the polishing hood body 105 and the cleaning through slot 31 may be communicated by means of disposing a through slot at the bottom of the polishing hood body 105 or configuring the bottom face of the polishing hood body 105 to have an opening, and so on. When the polishing hood body 105 is covered on the polishing roller 103, in an aspect, the polishing roller 103 can be protected, and in another aspect, the foreign matter of the current-collection box removed by the polishing roller 103 can be collected into the inner cavity of the polishing hood body 105, which, while facilitating the collection and the treatment of the foreign matter, can prevent splashing of the foreign matter from affecting the working environment.

Optionally, the cleaning device further includes a polishing fixing seat 106 and a polishing supporting seat 107. The polishing roller 103 is fixed on the polishing fixing seat 106, and the polishing fixing seat 106 is fixed on the polishing supporting seat 107.

It should be noted that the polishing fixing seat 106 may be a support having a connecting component. As an example, the polishing fixing seat 106 may include two lugs having a bolt hole, and by using the two lugs, the polishing roller 103 is enabled to be fixed between the two lugs, so that the polishing fixing seat 106 can enable the polishing roller 103 to maintain the position stability. The polishing fixing seat 106 is fixed on the bottom plate 3 via the polishing supporting seat 107. In this way, the polishing supporting seat 107 can support the polishing roller 103 to a certain extent, to prevent the polishing roller 1032 from being directly fixed on the bottom plate 3, and a sufficient room for the rotation of the polishing roller 103 can be left by using the polishing supporting seat 107, thus the entire structure is more compact.

Furthermore, the cleaning device further includes a polishing vacuum cleaner 108, the polishing vacuum cleaner 108 is in communication with the polishing hood body 105, the polishing vacuum cleaner 108 is electrically connected to the controller 23, and the controller 23 controls the polishing vacuum cleaner 108 to suck a foreign matter inside the polishing hood body 105.

It should be noted that the polishing vacuum cleaner 108 may be communicated with the polishing hood body 105 by using a pipeline. Accordingly, when the foreign matter stored in the polishing hood body 105 reaches a certain quantity, the foreign matter can be sucked into the polishing vacuum cleaner 108, thereby a long-term and effective operation of the polishing device is realized, and the normal movement of the polishing roller 103 is prevented being affected by accumulation of the foreign matter.

It should also be noted that a foreign-matter collecting box 19 may be disposed between the polishing vacuum cleaner 108 and the cleaning vacuum cleaner 18, and the foreign matter removed by the polishing vacuum cleaner 108 and the cleaning vacuum cleaner 18 is collected by using the foreign-matter collecting box 19, which facilitates the working personnel to collect and treat it subsequently.

Additionally, in the embodiments of the present disclosure, the diagnosis feeding-back assembly 4 may be used to determine the relative position between the cleaning device and the current-collection box and detect whether the current-collection box is in an abnormal state.

Specifically, in some embodiments, as shown in FIG. 2, the diagnosis feeding-back assembly 4 includes an in-position travel switch 41 and an off-position travel switch 42, the in-position travel switch 41 and the off-position travel switch 42 are fixed on the bottom plate 3, and the in-position travel switch 41 and the off-position travel switch 42 are electrically connected to the controller 23. The in-position travel switch 41 is configured to detect that the current-collection box is located at a first position of the bottom plate 3, and the off-position travel switch 42 is configured to detect that the current-collection box is located at a second position of the bottom plate 3. The first position refers to the position where the current-collection box and the bottom plate 3 coincide in a first direction, and the second position refers to the position where the bottom plate 3 is in stagger in the first direction, wherein the first direction refers to the direction perpendicular to the bottom plate 3.

It should be noted that the in-position travel switch 41 and the off-position travel switch 42 may be a type of position sensor. The in-position travel switch 41 is configured to detect that the current-collection box is located at the first position of the bottom plate 3, and because the first position refers to the position where the current-collection box and the bottom plate 3 coincide in the first direction, in other words, the in-position travel switch 41 is configured to detect that the bottom plate 3 has moved to the top of the current-collection box. At this point, the in-position travel switch 41 may be used to send a signal to the controller 23, and the controller 23 is used to control the cleaning assembly 1 to start the removal of the foreign matter of the current-collection box. Moreover, the off-position travel switch 42 is configured to detect that the current-collection box is located at a second position of the bottom plate 3, and because the second position refers to the position where the bottom plate 3 is in stagger in the first direction, in other words, the bottom plate 3 and the current-collection box are at positions where they do not coincide, or, in other words, the bottom plate 3 has left the top of the current-collection box. At this point, the off-position travel switch 42 may be used to send a signal to the controller 23, and the controller 23 controls the cleaning assembly 1 to stop the removal of the foreign matter of the current-collection box. In this way, the relative position between the cleaning device and the current-collection box can be determined accurately by using the in-position travel switch 41 and the off-position travel switch 42, so that the process of washing the current-collection box is more accurate and controllable.

Optionally, the diagnosis feeding-back assembly 4 further includes a contactor 43, the bottom plate 3 is provided with a cable, and the contactor 43 is electrically connected to the cable. The contactor 43 is configured to detect the power-on state of the current-collection box.

It should be noted that the contactor 43 may be one or more of a current sensor, a voltage sensor, a current switch and a voltage switch. In the detection, the contactor 43 may contact the current-collection box, and accordingly the contactor 43 is used to determine the power-on state of the current-collection box, thereby the function of detecting the state of the current-collection box is realized.

Furthermore, the diagnosis feeding-back assembly 4 further includes a position marking component 44, and the position marking component 44 is configured to mark a first target current-collection box, wherein the first target current-collection box refers to a current-collection box in a powering-off state. It should be noted that, when it is detected by the contactor 43 that the current-collection box is in the powering-off state, the current-collection box may be marked by using the position marking component 44, thereby the current-collection box in an abnormal state is facilitated to be subsequently treated.

Optionally, the diagnosis feeding-back assembly 4 further includes an indicator lamp 45, the indicator lamp 45 is electrically connected to the controller 23, and when it is detected by the contactor 43 that the current-collection box is in the powering-off state, the indicator lamp 45 is in a lightening state.

It should be noted that the contactor 43 may be electrically connected to the controller 23. When it is detected by the contactor 43 that the current-collection box is in the powering-off state, the contactor 43 may feed back a signal to the controller 23. The controller 23, by using an internal program, controls the indicator lamp 45 to be in the lightening state, to prompt the working personnel that the current-collection box is in an abnormal state. It should also be noted that the controller 23 may be a controlling device such as a programmable logic controller (PLC) element component, a single chip microcomputer and a board card, which is not limited in the embodiments of the present disclosure.

Optionally, the position marking component 44 includes a straight-line driver 441 and a marking pen 442. The marking pen 442 is fixed on the straight-line driver 441, and when it is detected by the contactor 43 that the current-collection box is in the powering-off state, the straight-line driver 441 drives the marking pen 442 to make a mark on the current-collection box.

It should be noted that the straight-line driver 441 may be a driving device driving a straight-line movement such as an electric actuator, an air cylinder and a screw rod. The straight-line driver 441 may be used to drive the marking pen 442 to move, so that, when it is detected by the contactor 43 that the current-collection box is in the powering-off state, the straight-line driver 441 can drive the marking pen 442 to make a mark on the current-collection box, wherein the mark is, for example, an underline, a cross and so on, thereby facilitating the working personnel to screen the current-collection boxes subsequently by using the mark made on the current-collection box by using the marking pen 442.

In some embodiments, the position marking component 44 further includes a display panel 443. The display panel 443 is electrically connected to the current-collection box, and when the current-collection box is marked by the marking pen 442, the display panel 443 displays the position of the current-collection box. In this way, by displaying the position of the current-collection box in an abnormal state on the display panel 443, it is facilitated that the working personnel checks and replaces the current-collection boxes subsequently.

Optionally, the cleaning device further includes a protecting hood body 5. The protecting hood body 5 is covered on the diagnosis feeding-back assembly 4 and the driving controlling assembly 2. The protecting hood body 5 can protect the diagnosis feeding-back assembly 4 and the driving controlling assembly 2 to a certain extent, thereby the service life of the cleaning device is prolonged.

It can be seen from the above embodiments that, in the embodiments of the present disclosure, because both of the cleaning assembly 1 and the driving controlling assembly 2 are fixed on the bottom plate 3, in the washing of the current-collection box, the bottom plate 3 can be moved to the top of the current-collection box, so that the cleaning assembly 1 and the driving controlling assembly 3 are located at the top of the current-collection box. Further, because the driving controlling assembly 2 and the cleaning assembly 1 are connected, and the bottom plate 3 is provided with a cleaning through slot 31. When it is detected by the diagnosis feeding-back assembly 4 that the current-collection box is located at the bottom of the bottom plate 3, the driving controlling assembly 2 can drive the cleaning assembly 1 to, by using the cleaning through slot 31, remove a foreign matter on the current-collection box, thereby the automated washing of the current-collection box is realized. In this way, in an aspect, by using the cleaning assembly 1 and the driving controlling assembly 3, the process of washing the current-collection box can be time-saving and labor-saving, and the washing of the current-collection box can be completed within a short time, which facilitates to increase the efficiency of the washing of the current-collection box. In another aspect, the relative position between the cleaning device and the current-collection box can be determined accurately by using the diagnosis feeding-back assembly 4, so that the process of washing the current-collection box is more accurate and controllable, and the current-collection box in an abnormal state can be diagnosed quickly by using the diagnosis feeding-back assembly 4, thereby the current-collection box in an abnormal state is facilitated to be subsequently maintained and replaced.

Additionally, in the embodiments of the present disclosure, because the cleaning assembly 1 further includes the polishing chain 101, the polishing chain wheel 102 and the polishing roller 103, the driving chain wheel 21 is a duplex chain wheel, the polishing roller 103 and the cleaning roller 12 are located at the two sides of the driving motor 22, the polishing chain wheel 102 is fixed at the input end of the polishing roller 103, the polishing chain 101 is connected to the polishing chain wheel 102 and the driving chain wheel 21, and the driving chain wheel 21 is fixed at an end of the polishing roller 103, secondary washing can be performed to the current-collection box by using the polishing roller 103, thereby the effect of the washing of the current-collection box is further improved. In addition, the diagnosis feeding-back assembly 4 may be used to determine the relative position between the cleaning device and the current-collection box and detect whether the current-collection box is in an abnormal state, which does not only enable the process of the foreign-matter removal of the current-collection box to be more accurate and controllable, but also facilitates the working personnel to subsequently replace the current-collection box in an abnormal state.

It should be noted that the embodiments of the description are described in the mode of progression, each of the embodiments emphatically describes the differences from the other embodiments, and the same or similar parts of the embodiments may be referred to each other.

Although alternative embodiments of the embodiments of the present disclosure have been described, once a person skilled in the art has known the essential inventive concept, he may make further variations and modifications on those embodiments. Therefore, the appended claims are intended to be interpreted as including the alternative embodiments and all of the variations and modifications that fall within the scope of the embodiments of the present disclosure.

Finally, it should also be noted that, herein, relation terms such as first and second are merely intended to distinguish one entity from another entity, and that does not necessarily require or imply that those entities have therebetween any such actual relation or order. Furthermore, the terms “include”, “contain” or any variants thereof are intended to cover non-exclusive inclusions, so that articles or terminal devices that include a series of elements do not only include those elements, but also include other elements that are not explicitly listed, or include the elements that are inherent to such articles or terminal devices. Unless further limitation is set forth, an element defined by the wording “including a . . . ” does not exclude additional same element in the article or terminal device including the element.

The technical solutions of the present disclosure have been described in detail above. The principle and the embodiments of the present disclosure are described herein with reference to the particular examples. Moreover, for a person skilled in the art, according to the principle and the implementations of the present disclosure, the particular embodiments and the range of application may be varied. In conclusion, the contents of the description should not be understood as limiting the present disclosure.

1. A cleaning device, configured for cleaning a current-collection box, wherein the cleaning device comprises a cleaning assembly, a driving controlling assembly, a bottom plate and a diagnosis feeding-back assembly;
both of the cleaning assembly and the driving controlling assembly are fixed on the bottom plate, and the driving controlling assembly and the cleaning assembly are connected;
the bottom plate is provided with a cleaning through slot, the diagnosis feeding-back assembly is connected to the bottom plate, and the diagnosis feeding-back assembly is configured to detect a relative position between the current-collection box and the bottom plate, and configured to detect a power-on state of the current-collection box; and
when it is detected by the diagnosis feeding-back assembly that the current-collection box is located at a bottom of the bottom plate, the driving controlling assembly drives the cleaning assembly to, by using the cleaning through slot, remove a foreign matter on the current-collection box.

2. The cleaning device according to claim 1, wherein the cleaning assembly comprises a cleaning chain, a cleaning roller and a cleaning chain wheel, and the driving controlling assembly comprises a driving chain wheel, a driving motor and a controller;
the controller and the driving motor are connected, and the controller controls the driving motor to rotate; and
a cleaning brush is fixed on a surface of the cleaning roller, the driving chain wheel is connected to an end of an output shaft of the driving motor, the cleaning chain is connected to the driving chain wheel and the cleaning chain wheel, and the cleaning chain wheel is fixed at an input end of the cleaning roller.

3. The cleaning device according to claim 2, wherein the cleaning assembly further comprises a cleaning hood body; and
the cleaning hood body is covered on the cleaning roller.

4. The cleaning device according to claim 2, wherein the cleaning device further comprises a cleaning fixing seat and a cleaning supporting seat; and
the cleaning roller is fixed on the cleaning fixing seat, and the cleaning fixing seat is fixed on the bottom plate via the cleaning supporting seat.

5. The cleaning device according to claim 3, wherein the cleaning device further comprises a cleaning vacuum cleaner; and
the cleaning vacuum cleaner is in communication with the cleaning hood body, the cleaning vacuum cleaner is electrically connected to the controller, and the controller controls the cleaning vacuum cleaner to suck a foreign matter in the cleaning hood body.

6. The cleaning device according to claim 2, wherein the cleaning assembly further comprises a polishing chain, a polishing chain wheel and a polishing roller, and the driving chain wheel is a duplex chain wheel;
the polishing roller and the cleaning roller are located at two sides of the driving motor; and
a polishing brush is fixed on the cleaning roller, the polishing chain wheel is fixed at an input end of the polishing roller, the polishing chain is connected to the polishing chain wheel and the driving chain wheel, and the driving chain wheel is fixed at an end of the polishing roller.

7. The cleaning device according to claim 6, wherein the cleaning assembly further comprises a polishing hood body; and
the polishing hood body is covered on the polishing roller.

8. The cleaning device according to claim 6, wherein the cleaning device further comprises a polishing fixing seat and a polishing supporting seat; and
the polishing roller is fixed on the polishing fixing seat, and the polishing fixing seat is fixed on the polishing supporting seat.

9. The cleaning device according to claim 7, wherein the cleaning device further comprises a polishing vacuum cleaner, the polishing vacuum cleaner is in communication with the polishing hood body, the polishing vacuum cleaner is electrically connected to the controller, and the controller controls the polishing vacuum cleaner to suck a foreign matter inside the polishing hood body.

10. The cleaning device according to claim 2, wherein the diagnosis feeding-back assembly comprises an in-position travel switch and an off-position travel switch, the in-position travel switch and the off-position travel switch are fixed on the bottom plate, and the in-position travel switch and the off-position travel switch are electrically connected to the controller; and
the in-position travel switch is configured to detect that the current-collection box is located at a first position of the bottom plate, and the off-position travel switch is configured to detect that the current-collection box is located at a second position of the bottom plate;
wherein the first position refers to a position where the current-collection box and the bottom plate coincide in a first direction, and the second position refers to a position where the bottom plate is in stagger in the first direction, wherein the first direction refers to a direction perpendicular to the bottom plate.

11. The cleaning device according to claim 10, wherein the diagnosis feeding-back assembly further comprises a contactor, the bottom plate is provided with a cable, and the contactor is electrically connected to the cable; and
the contactor is configured to detect the power-on state of the current-collection box.

12. The cleaning device according to claim 11, wherein the diagnosis feeding-back assembly further comprises a position marking component, and the position marking component is configured to mark a first target current-collection box, wherein the first target current-collection box refers to a current-collection box in a powering-off state.

13. The cleaning device according to claim 11, wherein the diagnosis feeding-back assembly further comprises an indicator lamp, the indicator lamp is electrically connected to the controller, and when it is detected by the contactor that the current-collection box is in a powering-off state, the indicator lamp is in a lightening state.

14. The cleaning device according to claim 12, wherein the position marking component comprises a straight-line driver and a marking pen; and
the marking pen is fixed on the straight-line driver, and when it is detected by the contactor that the current-collection box is in the powering-off state, the straight-line driver drives the marking pen to make a mark on the current-collection box.

15. The cleaning device according to claim 14, wherein the position marking component further comprises a display panel; and
the display panel is electrically connected to the current-collection box, and when the current-collection box is marked by the marking pen, the display panel displays a position of the current-collection box.

16. The cleaning device according to claim 2, wherein the cleaning device further comprises a protecting hood body; and
the protecting hood body is covered on the diagnosis feeding-back assembly and the driving controlling assembly.
